(19) United States
(12) Patent Application Publication
(10) Pub. No.: US 2026/0252354 A1
(43) Pub. Date: Aug. 27, 2026

(54) PREDICTION CIRCUITRY

(71) Applicant: Arm Limited, Cambridge (GB)

(72) Inventors: Thomas Andrew HARTIN, Austin, TX (US); Chang Joo LEE, Austin, TX (US); Somasundaram ARUNACHALAM, Raleigh, NC (US)

(21) Appl. No.: 19/065,004

(22) Filed: Feb. 27, 2025

(51) Int. Cl. G06F 9/38; G06F 9/50

(52) U.S. Cl. CPC G06F 9/3802; G06F 9/5055; G06F 2209/501

(57) ABSTRACT

An apparatus comprises fetch circuitry and prediction circuitry. A prediction storage structure provides prediction entries providing prediction information for a corresponding block of one or more instructions. The prediction circuitry performs a lookup for a given instruction in the prediction storage structure to identify instructions to fetch after the given instruction. Allocation control circuitry is configured to support internal allocation operations for prediction entries already stored in the prediction storage structure, wherein for a given prediction entry an internal allocation operation comprises, responsive to an internal allocation trigger event, allocating a new prediction entry at a different location in the prediction storage structure than the given prediction entry and populated with given prediction information provided by the given prediction entry. The allocation control circuitry selects, in dependence on a performance metric, a level of throttling to apply to the internal allocation operations.

### BACKGROUND

### Technical Field

The present technique relates to the field of data processing. More particularly, the present technique relates to prediction of instructions.

### Technical Background

A data processing apparatus may comprise fetch circuitry for fetching instructions for processing by processing circuitry. During some portions of a program the fetch circuitry may fetch instructions from sequential addresses, but certain instructions may trigger a change in program flow and require instructions to be fetched from a non-sequential address. It may not be known whether a particular instruction will trigger a change in program flow, and what the target of any change in program flow would be, until the instruction is executed. However, for performance reasons (e.g., to support pipelining of instructions) it can be useful to fetch instructions for processing before preceding instructions are executed. Therefore, prediction circuitry may be provided to identify instructions to be fetched by the fetch circuitry. Prediction circuitry may identify whether an instruction is a program flow changing instruction, and if so may predict a target address to which program flow may be changed, to allow the fetch circuitry to fetch instructions for processing without relying on the outcome of preceding instructions being known.

### SUMMARY

At least some examples of the present technique provide an apparatus, comprising:
fetch circuitry configured to fetch instructions for processing by processing circuitry;
prediction circuitry configured to identify instructions to be fetched by the fetch circuitry; and
a prediction storage structure providing a plurality of prediction entries, each prediction entry providing prediction information for a corresponding block of one or more instructions, wherein:
the prediction circuitry is configured to perform a lookup for a given instruction in the prediction storage structure to identify instructions to fetch after the given instruction;
the prediction storage structure comprises allocation control circuitry configured to support performing internal allocation operations for prediction entries already stored in the prediction storage structure, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
the allocation control circuitry is configured to select, in dependence on a performance metric, a level of throttling to apply to the internal allocation operations.

At least some examples provide a method, comprising:
fetching instructions for processing by processing circuitry;
providing a plurality of prediction entries, each prediction entry providing prediction information for a corresponding block of one or more instructions;
performing a lookup for a given instruction in the prediction storage structure to identify instructions to fetch after the given instruction;
performing internal allocation operations for the plurality of prediction entries, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
selecting, in dependence on a performance metric, a level of throttling to apply to the internal allocation operations.

At least some examples provide computer-readable code for fabrication of an apparatus, comprising:
fetch circuitry configured to fetch instructions for processing by processing circuitry;
prediction circuitry configured to identify instructions to be fetched by the fetch circuitry; and
a prediction storage structure providing a plurality of prediction entries, each prediction entry providing prediction information for a corresponding block of one or more instructions, wherein:
the prediction circuitry is configured to perform a lookup for a given instruction in the prediction storage structure to identify instructions to fetch after the given instruction;
the prediction storage structure comprises allocation control circuitry configured to support performing internal allocation operations for prediction entries already stored in the prediction storage structure, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
the allocation control circuitry is configured to select, in dependence on a performance metric, a level of throttling to apply to the internal allocation operations.

The computer-readable code may be provided on a computer-readable storage medium. The storage medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates a data processing apparatus according to examples of the present techniques.

FIG. 2 schematically illustrates a prediction storage structure comprising two prediction tables;

FIG. 3 illustrates an example encoding of entries in a prediction table;

FIGS. 4A and 4B provide examples of a fetch queue for tracking addresses identified for fetching.

FIG. 5 is a flow diagram illustrating a method of identifying instructions for fetching;

FIG. 6 is a flow diagram illustrating a method of fetching instructions identified by a fetch queue;

FIG. 7 is a flow diagram illustrating a method of throttling internal allocation operations;

FIG. 8 is a flow diagram illustrating a particular approach to throttling internal allocation operations; and

FIG. 9 illustrates a system and a chip-containing product.

### DESCRIPTION OF EXAMPLES

As discussed above, a data processing apparatus comprises fetch circuitry configured to fetch instructions for processing by processing circuitry, and prediction circuitry configured to identify instructions to be fetched by the fetch circuitry.

The data processing apparatus comprises a prediction storage structure (such as a branch target buffer (BTB) structure) providing a plurality of prediction entries. Each valid prediction entry provides prediction information for a corresponding block of one or more instructions. The prediction information associated with a block of instructions may indicate, for example, whether that block of instructions contains one or more control flow instructions (e.g., a branch instruction), the location of any control flow instructions within the block of instructions, whether any control flow instructions in the block are predicted to be taken or not taken, and the target address of any control flow instructions in the block. The prediction information may be allocated based on observed outcomes of instructions, and may be updated throughout a workload based on observed instances of instructions in the relevant block of instructions. The prediction information associated with a block of instructions can be used to identify subsequent instructions for fetching by the fetch circuitry.

The prediction circuitry is configured to perform a lookup for a given instruction in the prediction storage structure to identify instructions to fetch after the given instruction. The given instruction may for example be an instruction already selected for fetching, and the lookup performed to determine which instructions should be fetched after the given instruction. The lookup may for example identify whether the prediction storage structure provides prediction information associated with the block of instructions including the given instruction, and if so determine whether the block of instructions includes a taken control flow instruction, and if so determine the target address of the taken control flow instruction. This can allow the prediction circuitry to determine addresses of subsequent instructions to provide to the fetch circuitry for fetching after the given instruction. Providing prediction information associated with a block of several instructions can enable more efficient use of the prediction storage structure than providing prediction information for each individual instruction, for example reducing a number of lookups which may need to be performed in the prediction storage structure.

The prediction storage structure comprises allocation control circuitry configured to support internal allocation operations for prediction entries already stored in the prediction storage structure. For a given prediction entry, an internal allocation operation comprises allocating a new prediction entry at a location in the prediction storage structure different than the location of the given prediction entry, the new prediction entry being populated with at least a subset of the prediction information provided by the given prediction entry. Such internal allocations may be useful within the prediction storage structure to improve the latency of a lookup for the given prediction entry. For example, a new prediction entry may be allocated in a portion of the prediction storage structure having a lower lookup latency than the given prediction entry such that a future lookup for an address corresponding to the given prediction entry may hit against the new prediction entry in the prediction storage structure quicker than a lookup would hit against the given prediction entry. For example, as discussed below the prediction storage structure may comprise two or more prediction storage tables and the internal allocation operation may involve allocating an entry already stored in a higher latency table into a lower latency table. An internal allocation operation can reduce the time taken to access relevant prediction information in the prediction storage structure, and can allow quicker identification of subsequent instructions for fetching, which can be associated with improved performance by allowing instructions to be provided to the processing circuitry earlier. The internal allocation operation may be performed in response to an internal allocation trigger event, which is not particularly limited and examples of which will be discussed below.

Although providing support for internal allocations can be associated with improved performance, the present inventors have realised that internal allocations may not always be beneficial in all workloads.

For example, in some workloads a level of performance may not be dictated by the rate at which instructions can be identified by the prediction circuitry for fetching, as the rate of fetching of instructions by the fetch circuitry may be the dominant factor in performance. For instance, when a higher proportion of instructions identified for fetching are not available in an instruction cache there may be an increased delay associated with fetching instructions from a memory system and in this scenario increasing the rate at which instructions are identified by prediction circuitry may not directly result in increased performance. This scenario may arise for example in a large footprint workload in which a large number of different instructions are part of the working set of instructions. Internal allocation operations may incur some dynamic power cost, and whilst they may reduce the latency associated with accessing prediction information for a given instruction, in such workloads the reduced latency for the prediction circuitry may have a minimal effect on performance and therefore the internal allocation may merely represent wasted power usage.

The inventors have further realised that in some workloads, internal allocation operations may counter-intuitively be associated with decreased performance. As described above, internal allocation operations may move prediction information from one location in the prediction storage structure to another location in the prediction storage structure, but the internal allocation operations do not introduce new prediction information into the prediction storage structure. Therefore, whilst internal allocation operations may improve latency for lookups in the prediction storage structure, they do not improve a hit rate in the prediction storage structure. However, in some implementations, performing an internal allocation operation may decrease the capacity for allocation control circuitry to handle an external allocation allocating new prediction information into the prediction storage structure, which may decrease a hit rate in the prediction storage structure. For instance, the internal and external allocation operations may both be handled by the same circuitry having a limited capacity to handle allocations into the prediction storage structure. Therefore, performing an internal allocation operation may occupy a portion of the limited allocation capacity resulting in an external allocation operation being either missed altogether (due to lack of allocation capacity) or delayed, and in doing so may reduce a hit rate in the prediction storage structure as a lookup which may have hit against an entry allocated by an external allocation operation may instead miss if it is performed whilst the external allocation operation is dropped or delayed due to an internal allocation operation. When there is a lower hit rate in the prediction storage structure, the prediction circuitry may predict which instructions to fetch with a lower accuracy (as there may be a larger proportion of instructions for which the relevant prediction information is not present in the prediction storage structure). Lower accuracy prediction can impact performance, because the fetch circuitry may not fetch the correct instructions for the processing circuitry and delays may be incurred whilst waiting for the correct instructions to be fetched. Additionally, identifying incorrect instructions for fetching can mean that incorrect instructions are identified in caching structures (e.g., the instruction cache) for tracking recently fetched instructions. Such instruction cache pollution impacts performance, and allocating the incorrect instructions in the instruction cache also represents an inefficient use of power. Therefore, in some workloads internal allocation operations may be associated with decreased performance and increased power usage.

In examples of the present technique, the allocation control circuitry is configured to select, in dependence on a performance metric, a level of throttling to apply to the internal allocation operations. Throttling of internal allocation operations may be performed in various ways, but in general an increased level of throttling may reduce a number of internal allocation operations performed. As discussed above, in different workloads internal allocation operations may be more desirable (e.g., they may improve performance when performance is dictated by prediction throughput), or less desirable (e.g., they may decrease performance and increase power consumption). The present techniques provide the option to dynamically adjust a level of throttling of internal allocation operations depending on the particular workload, which can allow the advantages of internal allocations to be achieved in relevant workloads whilst reducing the negative impacts of internal allocations in other workloads. The performance metric is not particularly limited and examples will be discussed below, but in general the performance metric may be indicative of whether internal allocations are advantageous or disadvantageous for the given workload, to allow the level of throttling to be adjusted accordingly.

Some examples may support only two levels of throttling, although other examples may support three or more levels of throttling. In some examples the lowest level of throttling may be no throttling at all (e.g., permit all internal allocation operations in response to all internal allocation trigger events), and the highest level of throttling may be complete throttling (e.g., suppress all internal allocation operations), although it will be appreciated that in other examples the maximum and/or minimum levels of throttling may involve some partial degree of throttling.

In some examples, the allocation control circuitry may comprise at least one update queue to track allocation operations for the prediction storage structure. The number and arrangement of update queues is not particularly limited. For example, the prediction storage structure may include a number of separate tables and each table within the prediction storage structure may provide a separate update queue. The update queue may track allocation operations which are in progress but have not completed (e.g., tracking data to be allocated into the prediction storage structure whilst waiting for an entry to be made available). The update queue may be configured to track both the internal allocation operations and external allocation operations for prediction entries not already stored in the prediction storage structure (allocating new prediction information into the prediction storage structure). The update queue has a finite number of entries, and internal allocation operations can result in contention for update queue entries and higher latency for update visibility. For example, an increased volume of internal allocation operations may reduce capacity in the update queue to track external allocation operations. In some cases, this may cause external allocation operations to be dropped or cancelled due to lack of availability in the update queue. In addition, for example when entries in the update queue are handled in order, handling of update queue entries tracking internal allocation operations may delay handling of later update queue entries tracking external allocation operations, and therefore may delay allocation of prediction entries in response to external allocation operations. Therefore, internal allocation operations may result in missed allocation of, and/or delays to the visibility of, new prediction entries storing new prediction information, which can decrease the hit rate in the prediction storage structure as discussed above.

When tracking internal allocation operations in an update queue, an allocation threshold may be imposed to limit the number of internal allocation operations in the update queue. The allocation threshold may be imposed regardless of the level of throttling of internal allocation operations.

In some examples, an external allocation operation may comprise allocating a prediction entry corresponding to an observed block of instructions into the prediction storage structure in response to observing an outcome of an observed instruction in the observed instruction block. Delaying external allocation operations can therefore harm performance because a lookup in the prediction storage structure may miss whilst the external allocation is delayed, but the information which would have been provided by the external allocation operation may have been accurate prediction information identifying subsequent instructions for fetching based on an up-to-date observation of the relevant block of instructions.

As discussed above, the prediction storage structure is not particularly limited. In some examples, the prediction storage structure may comprise a first prediction table and a second prediction table, and for a given prediction entry in the second prediction table the internal allocation operation comprises allocating a new prediction entry in the first prediction table. The first prediction table may have a lower lookup latency than the second prediction table. For instance, the prediction storage structure may be a hierarchical structure of tables, with tables higher in the hierarchy having lower latency and tables lower in the hierarchy having a higher latency. Different tables in the prediction storage structure may be provided by different physical caches. The tables higher in the hierarchy may for example have a smaller capacity to enable the lower latency (e.g., having a smaller physical size, allowing a lookup in the structure to be performed in less time). Compared to a single table of prediction entries, a hierarchical prediction storage structure allows additional capacity to be provided for prediction entries whilst maintaining the opportunity for lower access latency (for the higher tables in the hierarchy).

The larger size of lower tables in the hierarchy means that access to prediction entries in the larger tables may be slow. Therefore, it can be desirable to support internal allocation operations to allow prediction entries to be moved from larger slower tables to smaller faster tables, so that the prediction entry can be accessed more quickly in future. This can be particularly beneficial when the number of branch instructions in the working set of instructions is not significantly larger than the size of the smallest prediction table (and therefore a large proportion of the instructions in the working set can be moved to the fastest prediction table at the start of a workload and the number of internal allocation operations thereafter may be low). In a larger footprint workload, particularly when a larger number of instructions cannot be tracked in the smallest table, the number of internal allocation operations may be significantly higher and may have a higher negative effect on performance. Therefore, it can be particularly beneficial to support dynamic throttling of internal allocation operations when using multiple prediction tables in a prediction storage structure.

For a given prediction entry in the second prediction table the internal allocation operation may comprise allocating a new prediction entry in the first prediction table. The previous entry from the second prediction table may be evicted (and therefore the entry may be swapped from the second table to the first table) or may be left in the second table. For example, the second table may or may not be inclusive of the first table. To make space for an entry to be allocated into the first prediction table, an existing entry may be evicted from the first prediction table into the second prediction table (or another prediction table). In a hierarchy of prediction tables, it will be appreciated that the first and second prediction tables may be any pair of prediction tables in the hierarchy. It will also be appreciated that a strict hierarchy of prediction tables is not essential, and more generally there may be one or more tables with lower access latency and one or more tables with higher access latency meaning that it is beneficial to support internal allocation operations for moving prediction entries between the tables for improved latency.

The internal allocation operation may be performed in response to an internal allocation trigger event indicating an opportunity to perform the internal allocation operation. The internal allocation trigger event may generally indicate that it is likely for the given prediction entry to be referenced soon and therefore that performance may be improved by moving the given prediction entry to a lower latency portion of the prediction storage structure. For example, the internal allocation trigger event may comprise a lookup in the prediction storage structure missing in the first prediction table and hitting against the given prediction entry in the second prediction table, and this may be a trigger to move the prediction entry from the second prediction table to the first prediction table (subject to any relevant throttling).

In some examples, the prediction circuitry and the fetch circuitry may be decoupled. For example, the prediction circuitry may be configured to allocate fetch entries in a fetch queue to identify instructions for fetching by the fetch circuitry. The prediction circuitry may allocate entries in the fetch queue at a first rate and the fetch circuitry may fetch instructions identified by the fetch queue at a different rate. The use of the fetch queue means that the prediction circuitry can operate separately from the fetch circuitry, and in particular can run significantly ahead of the fetch circuitry. The negative performance effects of misses in the prediction storage structure may be particularly significant in examples where the prediction circuitry can operate significantly ahead of the fetch circuitry. In particular, a miss in the prediction storage structure for a given instruction may mean that the given instruction is predicted incorrectly, and a large number of incorrect subsequent instructions may be identified in the fetch queue. With decoupled prediction and fetch circuitry, an incorrect prediction may take longer to identify and a larger amount of pollution may be caused in the fetch queue (and in the instruction cache as discussed below). Therefore, with decoupled fetch and prediction circuitry the advantages of dynamically throttling internal allocation operations may be particularly pronounced. However, it will be appreciated that the techniques discussed herein are not limited to examples including a fetch queue.

As discussed above, when a prediction entry is identified for a given instruction, the prediction circuitry may predict the outcome of the given instruction (i.e., which instructions should be subsequently fetched after the given instruction) based on prediction information provided by the prediction entry. For example the prediction information may identify that the given instruction is a branch instruction and may identify the target address of the given instruction. In some examples, when a lookup in the prediction storage structure misses for the given instruction and no prediction entry is identified for the given instruction, the prediction circuitry may make a default prediction for the given instruction. From a performance perspective, it may be better to make a default prediction than make no prediction at all, as the consequence of getting the prediction wrong may be similar to making no prediction at all.

The default prediction is not particularly limited. In some examples, the default prediction may be that the next instruction for fetching after the given instruction should be the instruction sequentially following the given instruction (i.e., the default prediction is that the given instruction is not a branch instruction). For example, according to the default approach the next fetch address may be predicted by applying a predetermined offset (e.g., the size of an instruction in memory) to the address of the given instruction. Predicting that the next instruction is the instruction sequentially following the given instruction may be a generally accurate prediction, as a large proportion of instructions may not change program flow. This also means that prediction entries may only be provided for program flow changing instructions (and not the large number of instructions which do not change program flow) as a miss in the prediction storage structure for a given instruction may implicitly indicate that the given instruction is not a program flow changing instruction. However, when the given instruction is a program flow changing instruction and a lookup in the prediction storage structure misses for the given instruction (e.g., as a result of internal allocation operations delaying updates to the prediction storage structure) then the default prediction may generate incorrect results for the given instruction, leading to the negative performance and power effects discussed above.

The fetch circuitry may generally fetch instructions from a memory system. To allow quicker access to instructions which might be fetched multiple times, an instruction cache may be provided to temporarily store instructions retrieved from memory in a previous fetch. The fetch circuitry may look up the instruction cache when attempting to fetch an instruction, and may be responsive to a lookup in the instruction cache missing for a target instruction to trigger the target instruction to be retrieved into the instruction cache from memory. Misprediction of instructions can have a significant impact on the instruction cache, because the fetch circuitry may attempt to fetch incorrect instructions, which may then be cached in the instruction cache causing significant cache pollution. Useful instructions may be evicted from the instruction cache to make room for the incorrect instructions, resulting in slower access to those instructions in future. Additionally, allocation of incorrect instructions into the instruction cache may incur a high dynamic power cost, and may contribute to increased memory bandwidth usage when attempting to retrieve the incorrect instructions into the instruction cache. Pollution of the instruction cache, caused by misprediction of instructions may therefore have significant negative effects on performance and power. Throttling of internal allocation operations may reduce misprediction of instructions by increasing a hit rate in the prediction storage structure, which may reduce the negative effects associated with pollution of the instruction cache.

As discussed above, throttling may be controlled in dependence on a performance metric. In some examples, the performance metric may be based on a number of instruction cache misses within a given period. A miss in the instruction cache may indicate an occurrence of an instruction which has not recently been used, and a number of misses in the instruction cache may be indicative of the number of instructions used for a current workload. A larger number of misses may indicate that the workload is a higher footprint workload (with a greater range of instructions) and a smaller number of misses may indicate that the workload is a lower footprint workload. As discussed earlier, the footprint of the workload may be relevant to throttling of internal allocation operations for various reasons. First, performance of a larger footprint workload with a greater number of instruction cache misses is more likely to be dominated by a fetch throughput rather than the prediction throughput, as fetches (missing in the instruction cache) are more likely to be a bottleneck than predictions. Internal allocation operations are therefore less likely to improve performance for a larger footprint workload, and hit rate in the prediction storage structure may be more important for a higher footprint workload. Second, a larger footprint workload is more likely to include a larger volume of internal allocation operations than a smaller footprint workload (e.g., the smallest prediction table may not be large enough to track all branch instructions in the workload), and therefore there is a higher likelihood of internal allocation operations having a negative impact on performance for a higher footprint workload. The number of misses in the instruction cache can therefore be used to form a performance metric controlling throttling of internal allocation operations.

The given period (or epoch) is not particularly limited. In some examples, the given period may be the period since the last reset. In other examples, the given period may be shorter such as a fixed number of predictions, a fixed number of instruction cache misses, and so on. By using a shorter given period, the allocation circuitry may be more responsive to changes in the workload to control the level of throttling. In some examples, the given period may be the current period. In other examples the given period may be a previous period, so that the values contributing to the performance metric have been obtained over a full period and are therefore more likely to be representative of a current workload.

The number of instruction cache misses may be determined indirectly. For example, an instruction cache may comprise a fill buffer for tracking instructions between issuing of a request to memory to retrieve the instruction data and the instruction data being returned from memory. An entry may be allocated to the fill buffer in response to an instruction cache miss, to retrieve the relevant data from memory. In some examples, a number of allocations into the fill buffer may be used as an analogue for the number of instruction cache misses. This could support simplified implementation in systems which may already count a number of fill buffer allocations for other purposes, for example.

In some examples, the performance metric may be based on a ratio of the number of instruction cache misses within the given period to a number of instructions successfully fetched by the fetch circuitry within the given period. The number of instruction cache misses within the given period may vary for the same workload depending on various factors, such as the rate at which instructions are identified for fetching. By calculating the performance metric based on both the number of instruction cache misses and the number of instructions successfully fetched within the given period, the performance metric may indicate the proportion of fetched instructions which miss in the cache, which may be more representative of the size of the workload than the number of instruction cache misses alone. For example, a high proportion of cache misses may be indicative of a high footprint workload, and a low proportion of cache misses may be indicative of a low footprint workload, regardless of the actual number of instruction cache misses in the given period.

In some examples, the allocation control circuitry may select a greater level of throttling when the ratio of instruction cache misses to instructions successfully fetched by the fetch circuitry is higher (indicating a higher footprint workload). As discussed above, the greater level of throttling may reduce the number of internal allocation operations and therefore reduce contention and latency for the prediction storage structure update path to improve the hit rate in the prediction storage structure (at the cost of some prediction latency) for higher footprint workloads where performance is more closely related to prediction accuracy than prediction latency.

In some examples, the performance metric may also or alternatively be based on a number of missed lookups in the prediction storage structure within a given period. The number of misses in the prediction storage structure may be higher for large footprint workloads due to the increased number of internal allocation operations and therefore the increased contention from internal allocation operations delaying external allocation operations. A larger number of misses in the prediction storage structure may indicate that performance could be improved by increasing throttling of internal allocation operations (to improve hit rate in the prediction storage structure) and a lower number of misses in the prediction storage structure may indicate that performance could be improved by reducing throttling of internal allocation operations (to improve latency of accesses in the prediction storage structure). The performance metric may therefore be based on the number of missed lookups in the prediction storage structure. It will be appreciated that various factors may contribute to the performance metric depending on implementation, and the precise combination of metrics which contribute to the performance metric is not particularly limited.

The allocation circuitry may perform throttling in various different ways. In general, internal allocation operations may be performed in response to internal allocation trigger events. Controlling the level of throttling may involve controlling a degree to which internal allocation trigger events may cause internal allocation operations to be performed. In a simple example, there may be two levels of throttling and a low level of throttling may involve permitting all internal allocation operations (e.g., performing internal allocation operations in response to all internal allocation trigger events) whilst a high level of throttling may involve suppressing all internal allocation operations (e.g., not performing internal allocation operations in response to any internal allocation trigger events). However, it can be useful to perform partial throttling to reduce a volume of internal allocation operations without completely preventing internal allocation operations. In particular, the inventors have determined that performance may often be improved be allowing a small number of internal allocations to take place even when a high level of throttling is desired. Therefore, in some examples, the allocation control circuitry may be configured to perform internal allocation operations in response to a selected proportion of internal allocation trigger events, wherein the selected proportion is selected based on the level of throttling. In the examples above, the selected proportion is either 0 or 1, but it will be appreciated that intermediate levels of throttling can enable internal allocation operations to be performed in response to a non-integer proportion of internal allocation trigger events.

In some examples, the selected proportion of internal allocation trigger events (which cause internal allocation operations to be performed) may be inversely proportional to the level of throttling. That is, for a greater level of throttling, a lower proportion of internal allocation trigger events may cause internal allocation operations to be performed, and hence a greater level of throttling reduces the number of internal allocation operations for the prediction storage structure.

Various approaches could be used for performing an internal allocation operation in response to a selected proportion of internal allocation trigger events. For example, for each internal allocation trigger event a random number could be generated and the corresponding internal allocation operation may be performed if the random number meets a comparison condition (e.g., if the random number is a multiple of a throttling value, where a smaller throttling value may correspond to a lower level of throttling). In other examples, the allocation control circuitry may be configured to maintain an internal allocation count indicating a number of internal allocation trigger events, and the allocation control circuitry may be configured to determine whether to perform a given internal allocation operation in dependence whether a current value of the internal allocation count meets a comparison criterion with respect to a throttling value selected in dependence on the level of throttling. That is, an internal allocation operation may be performed in response to every Nth internal allocation trigger event, where N is the throttling value. Again a smaller throttling value may correspond to a smaller level of throttling. Compared to the use of a random number, throttling based on the internal allocation count may reduce randomness in throttling.

Particular examples will now be discussed with reference to the Figures.

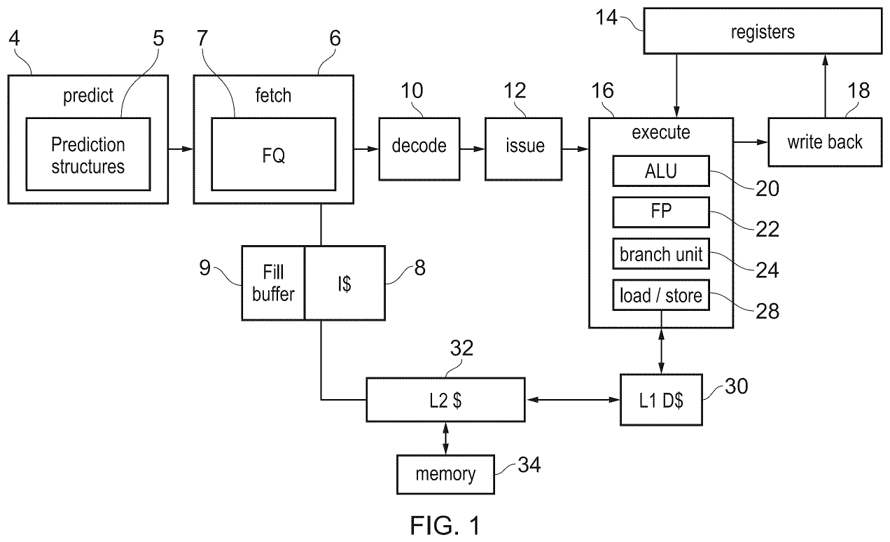

FIG. 1 schematically illustrates an example of a data processing apparatus 2 having a processing pipeline comprising a number of pipeline stages. The pipeline includes a branch predictor 4 (an example of prediction circuitry) for predicting outcomes of branch instructions and generating a series of fetch addresses of instructions to be fetched. A fetch stage 6 fetches the instructions identified by the fetch addresses from an instruction cache 8. A decode stage 10 decodes the fetched instructions to generate control information for controlling the subsequent stages of the pipeline. Although not illustrated in FIG. 1, a rename stage may perform register renaming to map architectural register specifiers identified by the instructions to physical register specifiers identifying registers 14 provided in hardware. Register renaming can be useful for supporting out-of-order execution as this can allow hazards between instructions specifying the same architectural register to be eliminated by mapping them to different physical registers in the hardware register file, to increase the likelihood that the instructions can be executed in a different order from their program order in which they were fetched from the cache 8, which can improve performance by allowing a later instruction to execute while an earlier instruction is waiting for an operand to become available. The ability to map architectural registers to different physical registers can also facilitate the rolling back of architectural state in the event of a branch misprediction. An issue stage 12 queues instructions awaiting execution until the required operands for processing those instructions are available in the registers 14. An execute stage 16 executes the instructions to carry out corresponding processing operations. A writeback stage 18 writes results of the executed instructions back to the registers 14.

The execute stage 16 may include a number of execution units such as a branch unit 24 for evaluating whether branch instructions have been correctly predicted, an ALU (arithmetic logic unit) 20 for performing arithmetic or logical operations, a floating-point unit 22 for performing operations using floating-point operands and a load/store unit 28 for performing load operations to load data from a memory system to the registers 14 or store operations to store data from the registers 14 to the memory system. In this example the memory system includes a level one data cache 30, a level two cache 32 which is shared between data and instructions, and main memory 34, but it will be appreciated that this is just one example of a possible memory hierarchy and other implementations can have further levels of cache or a different arrangement. The load/store unit 28 and the fetch unit 6 may use address translation information (which may be cached in a translation lookaside buffer or obtained from page tables in memory) to map virtual addresses generated by the pipeline to physical addresses identifying locations within the memory system. It will be appreciated that the pipeline shown in FIG. 1 is just one example and other examples may have different sets of pipeline stages or execution units.

The fetch circuitry 6 has access to a fetch queue 7 (shown in FIG. 1 as part of the fetch circuitry 6). The fetch queue is provided for queueing the fetch addresses identifying blocks of program instructions to be fetched from the instruction cache 8. The addresses placed in the fetch queue 7 represent addresses of blocks of instructions to be fetched from the instruction cache 8, which are derived from previous predictions of the branch predictor. The unit of instructions fetched in one block from the cache 8 may be referred to as a “fetch block” and may have a certain default size, e.g. 16, 32 or 64 bytes, although in some cases when the start address from which fetching is to be performed is not aligned with a natural fetch block boundary, a fetch of a partial fetch block may be performed with a size less than the default size.

The branch predictor 4 identifies fetch addresses in the fetch queue 7, indicating a sequence of instructions for fetching by the fetch circuitry 6 (predicted to be the sequence of instructions followed by executing a current workload). The branch predictor 4 provides at least one prediction storage structure 5 for generating the sequence of fetch addresses. The prediction storage structure 5 includes at least a branch target buffer (BTB, also referred to as a branch target address cache BTAC) structure for indicating whether an instruction at a particular fetch address is a branch instruction and predicting the target address to which a branch instruction will redirect program execution in the event that it is taken. Entries of the BTB may be populated and updated in response to observed outcomes of instructions at the execute stage.

The branch predictor 4 may step through addresses of instructions identified for fetching. For each fetch address, the branch predictor 4 triggers a lookup in the BTB 5 to obtain prediction information for predicting the subsequent fetch address. When the BTB 5 holds prediction information for the fetch address, then that information may be read out from the BTB 5 and used to form the subsequent fetch address. For instance, when the prediction information indicates that the fetch address is the address of a taken branch instruction, the subsequent fetch address may be a target address of that branch instruction as indicated by the prediction information. When the prediction information indicates that the instruction at the fetch address is not a taken branch instruction, the branch predictor 4 selects as the next fetch address an incremented version of the current fetch address, incremented by a certain stride amount so that the next fetch address used in a following cycle will follow on sequentially from the current fetch address. Similarly, if the BTB 5 lookup misses, the branch predictor 4 selects the next fetch address sequentially following the previous fetch address.

The next fetch address output by the branch predictor 4 is allocated to the fetch queue 7 so that in due course when that address reaches the front of the queue the corresponding block of instructions is fetched from the instruction cache by the fetch stage 6. Also the next fetch address is input as the current fetch address in a following processing cycle to trigger another lookup of the BTB 5 for that fetch address. This process continues cycle by cycle in order to step through the program code being executed. If a branch misprediction is detected at the branch unit 24 of FIG. 1, when the actual outcome of a branch instruction is different to the predicted outcome generated by the branch predictor 4, then signals are sent back to the fetch stage 6 to reset the fetch queue and resume fetching from the actual branch target address, and to update contents of the various prediction structures 5 based on the actual outcome of the branch to increase the likelihood of predictions being correct in future.

The branch predictor 4 may work in blocks of several instructions. For instance, a fetch address may be used to look up the BTB 5 to obtain prediction information for a block of instructions. The prediction information may indicate whether the block contains any taken branch instructions. If not, then the branch predictor can add addresses for the whole block (either individually or together) to the fetch queue 7 for fetching by the fetch circuitry (either individually or together as a block). If the block contains a taken branch instruction, then the branch predictor can determine the location of that taken branch instruction within the instruction block and can determine the target address of the branch instruction. The branch predictor can add addresses to the fetch queue 7 of the instruction block up to the taken branch instruction (or could fetch the whole block and indicate which instructions are not predicted to be on the taken path), and add addresses for subsequent instructions starting from the target address of the branch instruction.

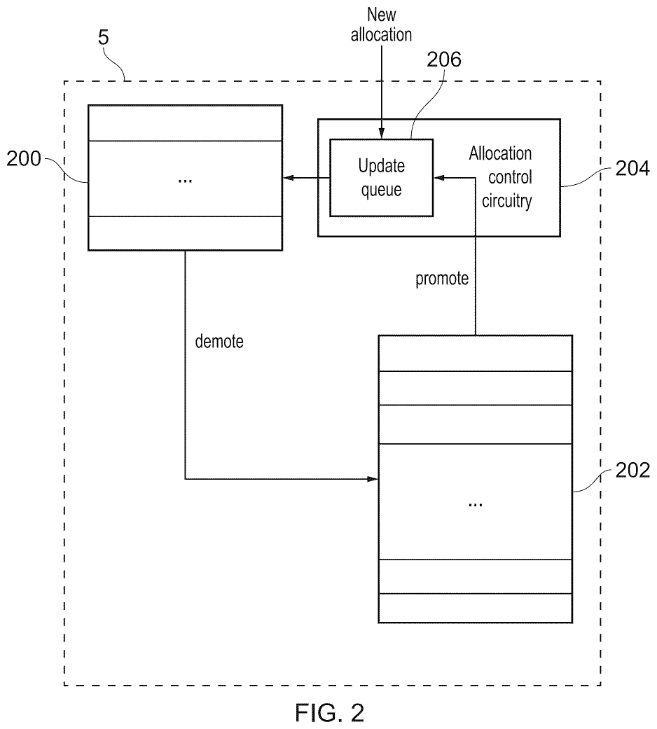

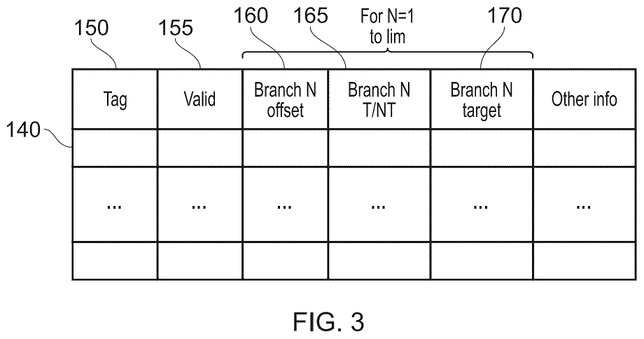

FIG. 2 schematically illustrates an example prediction storage structure 5 (e.g., a BTB). The BTB 5 holds prediction information for a number of branch instructions, and may comprise a plurality of entries. Each entry provides prediction information corresponding to a block of one or more instructions, as will be discussed in greater detail with reference to FIG. 3. The BTB 5 provides the plurality of prediction entries across several tables having different sizes. For instance a level 1 BTB table (L1BTB) 200 may contain a smaller number of prediction entries, and a level 2 BTB table (L2BTB) 202 may contain a larger number of prediction entries. The lookup latency of the smaller L1BTB 200 may be lower than the lookup latency of the larger L2BTB 202. Providing an L2BTB 202 increases the capacity for the BTB 5, allowing a larger number of instructions to be predicted accurately, without compromising latency of the L1BTB 200. The L1BTB 200 and the L2BTB 202 may be looked up in parallel, with the result of the L2BTB 202 lookup only being considered in the event of a L1BTB miss, or the L1BTB may be looked up first and the L2BTB only looked up in the event of a L1BTB miss.

If an instruction is likely to be predicted soon then a corresponding prediction entry can be moved from the L2BTB 202 to the L1BTB 200 to reduce the latency of accessing that prediction entry. Therefore, the hierarchical BTB 5 supports operations for moving prediction entries between tables. A promotion (or swap) operation can be used to move an entry from the L2BTB 202 to the L1BTB 200 (optionally evicting the entry from the L2BTB 202), and a demotion (or evict) operation can be used to move an entry from the L1BTB 200 to the L2BTB 202. A swap operation may be triggered in response to a BTB lookup missing in the L1BTB 200 but hitting in the L2BTB. The same instruction (or more generally the same block of instructions) may be accessed multiple times close together in a program, so a previous lookup in the BTB for a particular entry may indicate that the same entry will be accessed again soon, hence triggering a swap operation in response to a L2BTB hit.

The BTB 5 also supports new allocation operations to allocate new prediction entries into the BTB 5, for example in response to observed outcomes of branch instructions observed by the branch unit 24. Both new allocations and swaps may use the same BTB update path. In particular new allocations and swaps be tracked in the same limited-capacity update queue 206. The update queue 206 may track pending allocations for the prediction storage structure, for example as a first-in-first-out queue. Swaps can result in increased contention for the BTB update path and higher latency for update visibility for new allocations. For example, if a swap allocation is before a new allocation in the update queue 206 then the swap may be handled before the new allocation, which may delay visibility of the new allocation. This can decrease the BTB hit rate (e.g., lookups performed for information delayed in the update queue 206 would miss), which can significantly degrade performance. This may be especially true for decoupled predict/fetch implementations where the prediction circuitry 4 can run ahead of the fetch circuitry 6 and aggressively prefetch instruction cache lines. According to examples of the present technique, allocation control circuitry 204 supports dynamic throttling of swap operations to reduce contention for the update queue 206 and improve performance as discussed below.

The cache provided for each BTB table (e.g., each of the L1BTB 200 and the L2BTB 202) can be implemented in different ways. In some examples the cache could be fully associative, so that the branch information for a given branch can be placed at any location within the respective BTB table. However, in practice, a set associative cache implementation may be more efficient, and in this case the locations at which branch information for a given branch is allowed to be stored may be limited to a particular set (identified based on the instruction fetch address of the instruction block containing the branch) in order to reduce the number of entries which have to be looked up for a given fetch address during a branch target buffer lookup.

As shown in FIG. 3, each BTB entry 140 may include a number of fields. In particular, a field 150 can be provided to indicate a memory address indication for the entry, which may for example provide a tag corresponding to a portion of the instruction address for the branch instruction (and which may possibly be dependent on other information such as context identifiers or other identifiers of the current execution environment). A valid field 155 can be set to identify that the entry is valid. Each prediction entry 140 may provide prediction information for up to N instructions per block, and therefore N sets of instruction-specific fields may be provided per prediction entry. For instance, N sets of a branch offset field 160, taken indication field 165 and target address field 170 may be provided. The branch offset field may identify where, within the block of instructions corresponding to the same prediction entry 140, a particular branch instruction is located. The taken/not taken field 165 may indicate whether the branch at that offset is predicted to be taken or not taken, and a target address field 170 may indicate the target address of that branch instruction when it is taken. In some examples the taken indication field 165 may be provided by a separate structure looked up in parallel with the BTB 5 (e.g., a branch direction predictor BDP). It will be appreciated that FIG. 3 is merely an example of a prediction structure and various modifications may be made to the example of FIG. 3 without departing from the scope of the present invention. For instance, prediction entries 140 may also provide branch type information for each branch instruction identifying whether the branch is a direct branch, an indirect branch, a function call (e.g. branch with link instruction), a function return (e.g. a return instruction), etc. The branch type information could be used to identify which of various branch prediction mechanisms should be used to predict the direction and target address for the branch instruction. For instance, some branch instructions may be conditional, and hence whether the branch is taken or not will depend on assessment of those conditions, with the BDP being used to make a prediction as to whether the branch is taken or not taken. However, some types of branch instruction may be unconditionally executed. For example, it is typically the case that a return instruction will always be executed and the branch taken, and hence a prediction of the target address can be used for all occurrences of a return instruction.

In some examples, rather than indicating the full target address in the target address field 170, the prediction entry 140 may provide an offset from the address of the prediction entry (e.g., corresponding to the tag field 150). In other examples, the branch predictor 4 may comprise a region table which may provide a portion of the target address (an entry of the region table being selected based on a current execution context, for example) with the target address field 170 providing an offset from the address indicated in the region table.

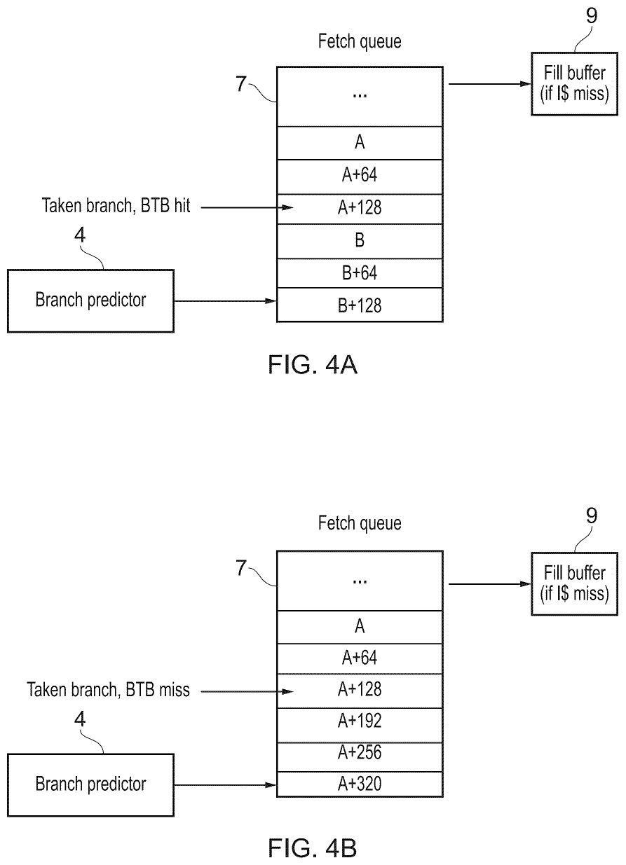

FIGS. 4A and 4B illustrate examples of a fetch queue 7. As described above, the fetch queue 7 tracks addresses of instructions (or instruction blocks) identified for fetching by the branch predictor 4. Fetch circuitry may fetch instructions from the top of the fetch queue 7 for passing to later stages of the pipeline for processing. The instruction cache 8 may be looked up based on addresses identified in the fetch queue 7, and if there is a miss in the instruction cache then the address of the missed lookup may be added to the fill buffer 9 so the instruction data can be retrieved into the instruction cache 8 for fetching. Lookups in the instruction cache may be performed for instructions which are not at the front of the fetch queue (e.g., while the fetch pipe is stalled during an instruction cache miss for the instruction at the front of the fetch queue) allowing instruction data to be brought into the instruction cache for instructions before they reach the front of the fetch queue. Therefore, some degree of instruction prefetching may be performed using the fetch queue, directed by the predictions made by the branch predictor 4.

In the examples of FIGS. 4A and 4B, instructions identified for fetching are used to look up the BTB 5. If there is a miss in the BTB 5, then the next instruction (or instruction block) may be identified sequentially, as a miss in the BTB 5 occurs when there is sequential code without branch instructions. A miss in the BTB 5 also occurs for branch instructions not covered by the BTB (e.g., the BTB does not contain relevant prediction information for the branch instruction), as discussed with reference to FIG. 4B.

In the example of FIG. 4A, address A is added to the fetch queue and the branch predictor 4 uses the address A to look up the BTB 5. The lookup misses (or hits against an entry indicating no taken branches), and therefore the address of the next sequential instruction block is added to the fetch queue, A+64. The address A+64 is used to look up the BTB 5, and a further miss results in the sequential address A+128 being added to the fetch queue. A lookup for address A+128 in the BTB 5 results in a hit, and the identified prediction information identifies that the instruction block A+128 includes a taken branch with the branch target having address B. Address B is therefore added to the fetch queue, and used to look up the BTB 5. This process continues to populate the fetch queue 7 with instructions for fetching by the fetch circuitry. Instructions added to the fetch queue 7 may be used to prefetch instructions into the instruction cache 8 in advance of those instructions reaching the front of the fetch queue, meaning that for example the instruction at address B may be fetched into the instruction cache 8 in advance of the fetch circuitry 6 attempting to fetch the instruction at address B into the pipeline. It will be appreciated that, even without instruction prefetching, the fetch queue allows instructions to be identified for fetching before preceding instructions are executed (e.g., the instructions in the instruction block identified by address B can pass down the pipeline before the instructions in instruction block A+128 are executed at the executed stage 16), and can therefore improve performance.

FIG. 4B illustrates a similar example, but in which the BTB 5 lookup for address A+128 resulted in a miss, despite instruction block A+128 including a taken branch instruction. For example the BTB miss may be the result of a swap operation delaying a new BTB allocation including prediction information for the A+128 block. The branch predictor 4 interprets the BTB miss to mean that instruction block A+128 does not include any taken branches and therefore adds the next sequential instruction block A+192 to the fetch queue 7. The subsequent instructions added to the fetch queue are along the incorrect path, and are not part of the correct program flow. However, this may not be determined until instruction block A+128 is executed. In the meantime, branch predictor 4 continues to add incorrect addresses to the fetch queue 7 (in FIG. 4B these are all sequential, but there is no reason the incorrect path cannot include taken branches). The addresses incorrectly added to the fetch queue may cause incorrect instructions to be fetched into the instruction cache 8 (either due to fetch queue prefetches or when the instructions reach the front of the fetch queue), which can harm performance due to future instruction cache misses taking longer to service, and may be associated with wasted power and memory bandwidth usage. In addition, performance is harmed due to the time taken to fetch the correct instructions into the pipeline once the branch misprediction is identified by the branch unit 24. It will therefore be appreciated that BTB misses may have significant negative impacts on the processing apparatus.

As discussed above, in certain workloads swap operations to move BTB entries from the L2BTB to the L1BTB can increase the likelihood of BTB misses by increasing contention for the BTB update path, causing new BTB allocations to be delayed or dropped altogether.

Swap operations may be more or less desirable depending on a current workload. In certain workloads the improved latency of accessing a swapped BTB entry may improve performance, but in other workloads swap operations may increase the likelihood of a BTB miss and result in the negative effects discussed with reference to FIG. 4B. In particular, in workloads including a large volume of different instructions (large footprint workloads) swap operations may be less desirable whereas in workloads including a smaller volume of instructions swap operations may be more desirable. In larger footprint workloads performance may be more closely related to the rate at which instructions can be fetched from memory (e.g., the rate at which instructions leave the fetch queue 7) rather than the rate at which instructions can be identified for fetching (e.g., the rate at which instructions enter the fetch queue 7), and therefore latency of accessing a particular BTB entry (which may be improved by swapping an entry into the L1 BTB and which may affect prediction throughput) may have little impact on performance. In addition, in a large footprint workload the potential volume of swap operations may be larger as the working set of instructions may not fit into the L1BTB, meaning that in large footprint workloads swap operations may be associated with a greater reduction in BTB hit rate. In large footprint workloads, the hit rate in the BTB overall (which is not improved by swap operations) may be the most important factor for performance and therefore swap operations may be less desirable than in smaller footprint workloads.

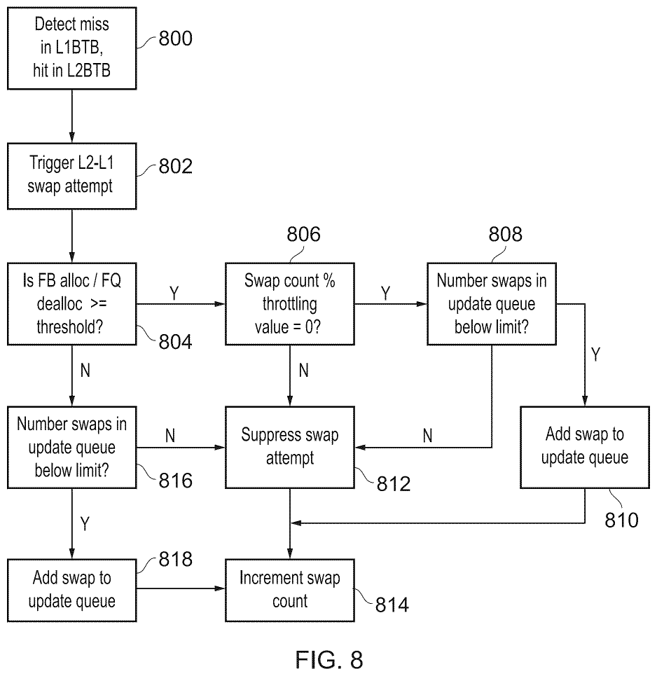

According to the present techniques the number of swap operations may be dynamically throttled to reduce a number of swap operations, with the level of throttling depending on a performance metric of the current workload. In particular throttling may reduce a proportion of swap attempts which actually result in swap operations. A swap attempt may occur any time an opportunity for swapping a BTB entry is identified (e.g., on a L1BTB miss and L2BTB hit for a particular address). Various approaches could be used for filtering the number of swap attempts which result in swaps, where the level of filtering can be adjusted based on a performance metric. A particular example will be discussed with reference to FIG. 8, but it will be appreciated that this is merely an example.

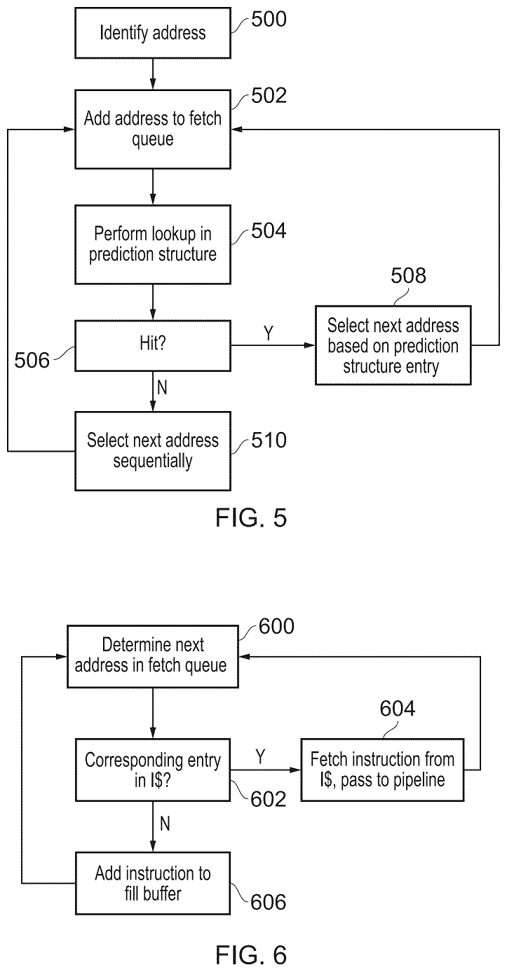

FIG. 5 is a flow diagram illustrating a method for a branch predictor 4, for identifying addresses for adding to a fetch queue 7.

At step 500 the branch predictor 4 identifies a fetch address. In general, this may be the next address predicted to follow the previous fetch address (e.g., as determined at steps 508 or 510). The first fetch address may be initialised during startup or provided to the prediction circuitry following an incorrect prediction triggering a pipeline flush.

At step 502 the identified address is added to the fetch queue 7.

At step 504 the identified address is used to perform a lookup in a prediction structure 5 (e.g., a BTB) so that the branch predictor can determine whether the instruction (or an instruction block identified by the instruction) includes a taken branch instruction which will result in a change in program flow. In examples including multiple tables in the prediction storage structure, all tables may be looked up simultaneously or tables may be looked up in order if a lookup in a preceding table misses.

At step 506 it is determined whether there was a hit in the prediction storage structure 5 (in any of the tables). If so, then at step 508 the branch predictor selects the next address based on the information storage in the prediction entry (e.g., as illustrated in FIG. 3). For example, if the prediction information indicates that there is a taken branch instruction in the instruction block then the target address of the branch instruction may be added to the fetch queue 7.

If the prediction storage structure lookup misses, then at step 510 the branch predictor 4 predicts that the instruction block does not include any branch instructions and therefore selects the next instruction for adding to the fetch queue 7 sequentially, for example by incrementing the identified address by the size of an instruction or instruction block in memory.

After steps 508 and 510, the next instruction becomes the identified instruction and the process continues from step 502.

FIG. 6 is a flow diagram illustrating a method for fetch circuitry 6 for fetching instructions identified by a fetch queue 7.

At step 600 the fetch circuitry identifies the next address in the fetch queue. This may be the address at the front of the fetch queue (e.g., the oldest address in the fetch queue).

At step 602 the fetch circuitry 6 performs a lookup in the instruction cache 8 for the identified address. If there is a hit in the instruction cache 8, then at step 604 the instruction is retrieved from the instruction cache 8 and provided to the decode stage 10 for processing by the pipeline. The hit entry is then deallocated from the fetch queue 7.

If there is a miss in the instruction cache, then at step 606 the instruction is instead retrieved from the memory system for processing, and allocated to the instruction cache 8. The address may for example be tracked in the fill buffer 9 whilst waiting for the instruction to be retrieved into the instruction cache 8.

Steps 600, 602, and 606 may also be performed for instructions which are not at the front of the fetch queue to prefetch instructions into the instruction cache 8.

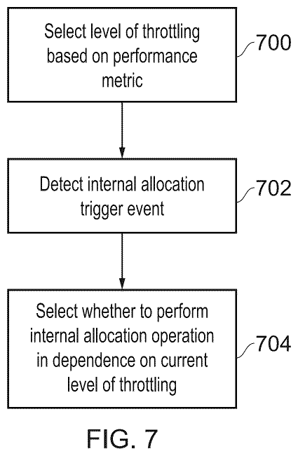

FIG. 7 is a flow diagram illustrating a method of throttling internal allocation operations performed in a prediction storage structure 5.

At step 700, allocation control circuitry 204 selects a level of throttling depending on a performance metric. The performance metric may be a performance metric determined for a previous epoch, where the length of the epoch could be determined in various ways. The performance metric may include various measurements of the processing apparatus which may indicate whether internal allocations are more or less desirable for the current workload. For example, the performance metric may indicate a relation between an instruction fetch throughput and a prediction throughput (e.g., the rate of instructions leaving the fetch queue compared to the rate of instructions entering the fetch queue). If the instruction fetch throughput is high related to the prediction throughput then prediction latency may be more important for performance, and reducing prediction latency may improve performance (favouring reduced throttling and increased swaps) whereas if instruction fetch throughput is low related to the prediction throughput then reducing the number of swaps by increasing throttling may improve performance by reducing contention of swaps with critical new allocations and improving the prediction storage structure hit rate. The performance metric may additionally, or alternatively, include a more direct measurement of a hit rate in the prediction storage structure 5 (e.g., BTB). The hit rate in the prediction storage structure may both indicate whether the current workload is high footprint or not (as a higher footprint workload may have a higher miss rate in the prediction storage structure) as well as indicating whether the current volume of swap operations is acceptable (a decreased hit rate in the prediction storage structure may indicate that a high volume of swap operations are contending with critical new allocations).

The selected level of throttling may for example control a proportion of swap attempts resulting in swap operations. At step 702, the allocation control circuitry detects an internal allocation trigger event (swap attempt). For example, a lookup in the prediction storage structure may miss in a first table but hit in a lower latency table, indicating an opportunity to move the entry from the lower latency table to the first table. At step 704, the allocation control circuitry controls whether to perform the internal allocation (the swap) depending on the current level of throttling. For a higher level of throttling, a lower proportion of internal allocation trigger events (detected at step 702) result in internal allocation operations being performed at step 704.

FIG. 8 is a flow diagram illustrating a particular method of dynamically throttling swap attempts for a hierarchical BTB as illustrated in FIG. 2.

In the example of FIG. 8, the performance metric is based on a ratio between a number of allocations into the fill buffer 9 and a number of deallocations from the fetch queue 7 in a preceding epoch. The number of deallocations from the fetch queue is indicative of a fetch throughput. An allocation into the fill buffer may be triggered when a lookup in the instruction cache misses, and therefore the ratio between a number of fill buffer allocations to a number of fetch queue deallocations may generally indicate a proportion of instruction cache lookups which missed, where a higher value may be indicative of a larger footprint workload.

The following pseudocode provides an example of the approach shown in FIG. 8:

```
For every FQ dealloc:
    l2btb_fq_dealloc_period++; // Completed a fetch
For every FB alloc:
    l2btb_fb_alloc_period++; // I-cache miss
For every L2 -> L1 swap attempt:
    swap_count++;
For each BTB update appended to the update queue and each BTB update removed from
the update queue:
  num_swaps_in_update_queue = count the number of swaps in the update queue;
// Changing the epoch:
For every l2btb_fq_dealloc_period FQ deallocs: // Tunable epoch, e.g., 64K
    l2btb_fb_per_fq = l2btb_fb_alloc_per_period / l2btb_fq_dealloc_period;
    if (l2btb_fb_per_fq >= throttle_enable_threshold):
      throttle_swaps_to_update_queue( );
    else:
      send_swaps_to_queue( );
    // Reset epoch
    l2btb_fq_dealloc_period = 0;
    l2btb_fb_alloc_period = 0;
throttle_swaps_to_update_queue( ):
  While throttle_enabled and swap_from_l2_to_l1( ) and (swap_count % throttle_threshold
== 0):
    send_swap_to_update_queue( );
send_swap_to_update_queue( ):
  if num_swaps_in_update_queue < max_swaps_in_update_queue:
    insert_swap_into_update_queue( );
  // otherwise, the swap is dropped
```

The counter l2btb_fq_dealloc_period is incremented each time an entry is deallocated from the fetch queue (FQ) 7. The counter l2btb_fb_alloc_period is incremented each time an entry is allocated into the fill buffer (FB) 9. These two counters provide the performance metric for a particular epoch. A further counter, swap_count, tracks swap attempts and is incremented each time an opportunity is identified to move a BTB entry from the L2BTB to the L1BTB. The variable num_swaps_in_update_queue indicates a number of swap allocations currently recorded in the update queue 206.

The epoch is reset every time the counter l2btb_fq_dealloc_period reaches a certain value, which can vary depending on implementation and in the example given above is 64K. It will be appreciated that other approaches could be used to reset the epoch (e.g., counting processor cycles). At the end of each epoch, a ratio l2btb_fb_per_fq is calculated indicating the ratio of fill buffer allocations to fetch queue deallocations in the epoch. The calculated ratio is the performance metric controlling the next epoch, and selects whether to use throttling (throttle_swaps_to_update_queue( )) or not (send_swaps_to_queue( )) for the next epoch. In this example there are only two levels of throttling, but it will be appreciated that more levels could be used. In this example, the ratio is compared to a throttling enable threshold (throttle_enable_threshold) to determine whether to apply throttling or not. The throttling enable threshold may be selected for particular implementations. If more than two levels of throttling were supported, two or more throttling enable thresholds may be provided to select between three or more different levels of throttling. Once the level of throttling has been selected for the next epoch, the two performance counters l2btb_fq_dealloc_period and l2btb_fb_alloc_period are reset to track FQ deallocations and FB allocations for the next epoch.

In this example, throttling is either enabled or not enabled. When throttling is enabled for an epoch (throttle_swaps_to_update_queue( )), each attempted swap from the L2BTB to the L1BTB triggers a check to see if the swap is allowed. In particular, it is determined whether the current value of swap_count is a multiple of a throttling value (throttle_threshold). For instance, it is determined whether swap_count modulo throttle_threshold is equal to zero. If so, the swap is permitted. If not, the swap is dropped. In either case the swap count is then incremented to control whether the next swap attempt is permitted. The throttle_threshold is a value controlling a degree of throttling. In the example of FIG. 8 there is only a single throttle_threshold controlling a degree of throttling for the throttled state, but in other examples different values of throttle_threshold could be used for different levels of throttling. In some examples, throttle_threshold may be a power-of-two value selected from {2, 4, 8, 16, 32, 64, 128, 256, 512, 1024}. The proportion of permitted swaps is 1/throttle_threshold. For instance, when using a throttle_threshold of 64, 1.5625% of swap attempts result in a swap operation.

When throttling is not enabled for an epoch, each swap attempt may be successful. This could be thought of as throttling with a throttle_threshold of 1. In this example, regardless of the current level of throttling there may also be a fixed limit on the number of swap operations tracked in the update queue 206, which is max_swaps_in_update_queue (e.g., 1).

This process is illustrated in FIG. 8. At step 800 a BTB lookup for a given address misses in the L1BTB 200 and hits in the L2BTB 202, triggering a swap attempt at step 802 attempting to swap the hit entry from the L2BTB to the L1BTB (to reduce prediction latency for future predictions involving the hit entry). At step 804 it is determined whether the ratio l2btb_fb_per_fq in the previous epoch is above or below the throttling enable threshold. If so, the swap attempt is throttled and at step 806 it is determined whether the current swap_count is a multiple of the throttling value throttle_threshold. If not, then at step 812 the swap attempt is suppressed and the hit entry is not added to the update queue 206. The swap_count is then incremented at step 814.

However, if swap_count is a multiple of throttle_threshold, then at step 808 it is determined whether the number of swaps currently in the update queue 206 is below the limit max_swaps_in_update_queue. If not, again the swap is suppressed at step 812. However, if the current number of swaps is below the limit, then at step 810 the hit entry is added to the update queue 206 to be allocated into the L1BTB. The previous entry in the L2BTB is optionally deallocated depending on implementation. The swap_count is then incremented at step 814.

If at step 804 it is determined that throttling is not enabled, then no comparison takes place and at step 816 it is only determined whether the number of swaps currently in the update queue 206 is below the limit max_swaps_in_update_queue. If so, then at step 818 the swap is added to the update queue 206, and if not the swap is suppressed at step 812. In either case, the swap count is the incremented at step 814.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

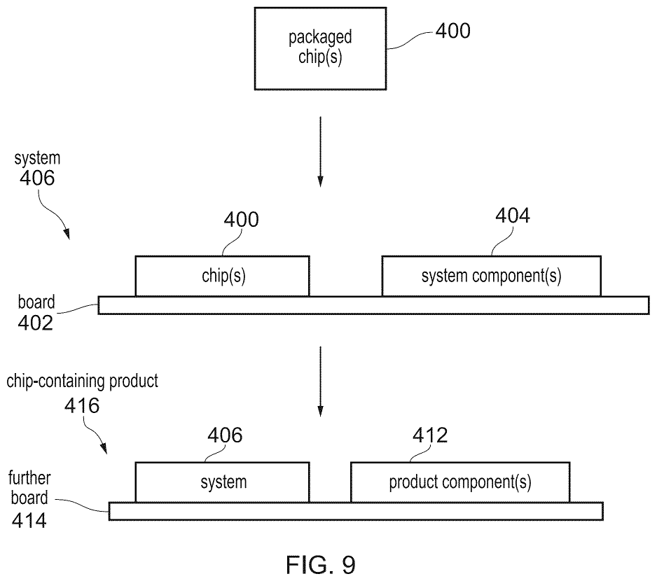

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a larger chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus, comprising:
fetch circuitry configured to fetch instructions for processing by processing circuitry;
prediction circuitry configured to identify instructions to be fetched by the fetch circuitry; and
a prediction storage structure providing a plurality of prediction entries, each prediction entry providing prediction information for a corresponding block of one or more instructions, wherein:
the prediction circuitry is configured to perform a lookup for a given instruction in the prediction storage structure to identify instructions to fetch after the given instruction;
the prediction storage structure comprises allocation control circuitry configured to support performing internal allocation operations for prediction entries already stored in the prediction storage structure, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
the allocation control circuitry is configured to select, in dependence on a performance metric, a level of throttling to apply to the internal allocation operations.

2. The apparatus according to clause 1, wherein the allocation control circuitry comprises an update queue to track allocation operations for the prediction storage structure, wherein the update queue is configured to track both:
the internal allocation operations, and external allocation operations for prediction entries not already stored in the prediction storage structure.

3. The apparatus according to clause 2, wherein an external allocation operation comprises allocating a prediction entry corresponding to an observed instruction block into the prediction storage structure in response to observing an outcome of an observed instruction in the observed instruction block.

4. The apparatus according to any preceding clause, wherein the prediction storage structure comprises a first prediction table and a second prediction table, and for a given prediction entry in the second prediction table the internal allocation operation comprises allocating a new prediction entry in the first prediction table.

5. The apparatus according to clause 4, wherein the first prediction table has a lower lookup latency than the second prediction table.

6. The apparatus according to any of clauses 4 and 5, wherein the internal allocation trigger event comprises a lookup in the prediction storage structure missing in the first prediction table and hitting against the given prediction entry in the second prediction table.

7. The apparatus according to any preceding clause, wherein the prediction circuitry is configured to allocate fetch entries in a fetch queue to identify instructions for fetching by the fetch circuitry.

8. The apparatus according to any preceding clause, wherein the prediction circuitry is responsive to the lookup in the prediction storage structure missing for the given instruction to make a default prediction for a subsequent instruction for fetching after the given instruction.

9. The apparatus according to any preceding clause, wherein the fetch circuitry is configured to fetch instructions from an instruction cache; and
the fetch circuitry is responsive to a lookup in the instruction cache missing for a target instruction to trigger the target instruction to be retrieved into the instruction cache.

10. The apparatus according to clause 9, wherein the performance metric is based on a number of instruction cache misses within a given period.

11. The apparatus according to clause 10, wherein the performance metric is based on a ratio of the number of instruction cache misses within the given period to a number of instructions successfully fetched by the fetch circuitry within the given period.

12. The apparatus according to clause 11, wherein the allocation control circuitry is configured to select a greater level of throttling when the ratio has a higher value.

13. The apparatus according to any preceding clause, wherein the performance metric is based on a number of missed lookups in the prediction storage structure within a given period.

14. The apparatus according to any preceding clause, wherein the allocation control circuitry is configured to perform internal allocation operations in response to a selected proportion of internal allocation trigger events, wherein the selected proportion is selected based on the level of throttling.

15. The apparatus according to clause 14, wherein the selected proportion is inversely proportional to the level of throttling.

16. The apparatus according to any preceding clause, wherein the allocation control circuitry is configured to maintain an internal allocation count indicating a number of internal allocation trigger events, and the allocation control circuitry is configured to determine whether to perform a given internal allocation operation in dependence whether a current value of the internal allocation count meets a comparison criterion with respect to a throttling value selected in dependence on the level of throttling.

17. A system comprising:
the apparatus of any preceding clause, implemented in at least one packaged chip;
at least one system component; and
a board,
wherein the at least one packaged chip and the at least one system component are assembled on the board.

18. A chip-containing product comprising the system of clause 17, wherein the system is assembled on a further board with at least one other product component.

19. A method, comprising:
fetching instructions for processing by processing circuitry;
providing a plurality of prediction entries, each prediction entry providing prediction information for a corresponding block of one or more instructions;
performing a lookup for a given instruction in the prediction storage structure to identify instructions to fetch after the given instruction;
performing internal allocation operations for the plurality of prediction entries, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
selecting, in dependence on a performance metric, a level of throttling to apply to the internal allocation operations.

20. Computer-readable code for fabrication of an apparatus, comprising:
fetch circuitry configured to fetch instructions for processing by processing circuitry;
prediction circuitry configured to identify instructions to be fetched by the fetch circuitry; and
a prediction storage structure providing a plurality of prediction entries, each prediction entry providing prediction information for a corresponding block of one or more instructions, wherein:
the prediction circuitry is configured to perform a lookup for a given instruction in the prediction storage structure to identify instructions to fetch after the given instruction;
the prediction storage structure comprises allocation control circuitry configured to support performing internal allocation operations for prediction entries already stored in the prediction storage structure, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
the allocation control circuitry is configured to select, in dependence on a performance metric, a level of throttling to apply to the internal allocation operations.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
fetch circuitry configured to fetch instructions for processing by processing circuitry;
prediction circuitry configured to identify instructions to be fetched by the fetch circuitry; and
a prediction storage structure providing a plurality of prediction entries, each prediction entry providing prediction information for a corresponding block of one or more instructions, wherein:
the prediction circuitry is configured to perform a lookup for a given instruction in the prediction storage structure to identify instructions to fetch after the given instruction;
the prediction storage structure comprises allocation control circuitry configured to support performing internal allocation operations for prediction entries already stored in the prediction storage structure, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
the allocation control circuitry is configured to select, in dependence on a performance metric, a level of throttling to apply to the internal allocation operations.

2. The apparatus according to claim 1, wherein the allocation control circuitry comprises an update queue to track allocation operations for the prediction storage structure, wherein the update queue is configured to track both:
the internal allocation operations, and
external allocation operations for prediction entries not already stored in the prediction storage structure.

3. The apparatus according to claim 2, wherein an external allocation operation comprises allocating a prediction entry corresponding to an observed block of instructions into the prediction storage structure in response to observing an outcome of an observed instruction in the observed block of instructions.

4. The apparatus according to claim 1, wherein the prediction storage structure comprises a first prediction table and a second prediction table, and for a given prediction entry in the second prediction table the internal allocation operation comprises allocating a new prediction entry in the first prediction table.

5. The apparatus according to claim 4, wherein the first prediction table has a lower lookup latency than the second prediction table.

6. The apparatus according to claim 4, wherein the internal allocation trigger event comprises a lookup in the prediction storage structure missing in the first prediction table and hitting against the given prediction entry in the second prediction table.

7. The apparatus according to claim 1, wherein the prediction circuitry is configured to allocate fetch entries in a fetch queue to identify instructions for fetching by the fetch circuitry.

8. The apparatus according to claim 1, wherein the prediction circuitry is responsive to the lookup in the prediction storage structure missing for the given instruction to make a default prediction for a subsequent instruction for fetching after the given instruction.

9. The apparatus according to claim 1, wherein the fetch circuitry is configured to fetch instructions from an instruction cache; and
the fetch circuitry is responsive to a lookup in the instruction cache missing for a target instruction to trigger the target instruction to be retrieved into the instruction cache.

10. The apparatus according to claim 9, wherein the performance metric is based on a number of instruction cache misses within a given period.

11. The apparatus according to claim 10, wherein the performance metric is based on a ratio of the number of instruction cache misses within the given period to a number of instructions successfully fetched by the fetch circuitry within the given period.

12. The apparatus according to claim 11, wherein the allocation control circuitry is configured to select a greater level of throttling when the ratio has a higher value.

13. The apparatus according to claim 1, wherein the performance metric is based on a number of missed lookups in the prediction storage structure within a given period.

14. The apparatus according to claim 1, wherein the allocation control circuitry is configured to perform internal allocation operations in response to a selected proportion of internal allocation trigger events, wherein the selected proportion is selected based on the level of throttling.

15. The apparatus according to claim 14, wherein the selected proportion is inversely proportional to the level of throttling.

16. The apparatus according to claim 1, wherein the allocation control circuitry is configured to maintain an internal allocation count indicating a number of internal allocation trigger events, and the allocation control circuitry is configured to determine whether to perform a given internal allocation operation in dependence whether a current value of the internal allocation count meets a comparison criterion with respect to a throttling value selected in dependence on the level of throttling.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method, comprising:
fetching instructions for processing by processing circuitry;
providing a plurality of prediction entries, each prediction entry providing prediction information for a corresponding block of one or more instructions;
performing a lookup for a given instruction in the prediction storage structure to identify instructions to fetch after the given instruction;
performing internal allocation operations for the plurality of prediction entries, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
selecting, in dependence on a performance metric, a level of throttling to apply to the internal allocation operations.

20. A non-transitory computer-readable medium storing computer-readable code for fabrication of an apparatus, comprising:
fetch circuitry configured to fetch instructions for processing by processing circuitry;
prediction circuitry configured to identify instructions to be fetched by the fetch circuitry; and
a prediction storage structure providing a plurality of prediction entries, each prediction entry providing prediction information for a corresponding block of one or more instructions, wherein:
the prediction circuitry is configured to perform a lookup for a given instruction in the prediction storage structure to identify instructions to fetch after the given instruction;
the prediction storage structure comprises allocation control circuitry configured to support performing internal allocation operations for prediction entries already stored in the prediction storage structure, wherein for a given prediction entry an internal allocation operation comprises, responsive to an internal allocation trigger event, allocating a new prediction entry at a different location in the prediction storage structure than the given prediction entry and populated with given prediction information provided by the given prediction entry; and
the allocation control circuitry is configured to select, in dependence on a performance metric, a level of throttling to apply to the internal allocation operations.
